(19) United States
(12) Patent Application Publication
(10) Pub. No.: US 2015/0286808 A1
(43) Pub. Date: Oct. 8, 2015

(54) MARKED IMAGE FILE SECURITY SYSTEM AND PROCESS

(71) Applicant: Mach 1 Development, Inc., Leesburg, VA (US)

(72) Inventors: Paul Greene, Leesburg, VA (US); Charles Burgoyne, Austin, TX (US)

(73) Assignee: MACH 1 DEVELOPMENT, INC., Leesburg, VA (US)

(21) Appl. No.: 14/246,000

(22) Filed: Apr. 4, 2014

(51) Int. Cl. G06F 21/16; G06F 17/30

(52) U.S. Cl. CPC G06F 21/16; G06F 17/30722; G06F 17/30144; G06F 17/30867; G06F 17/30268; G06F 2221/0737

(57) ABSTRACT

The present invention is a system and process for updating a marked image file. The system and process seeks a marker that is inertly placed in an image file such that the marker is nonconforming to file type schema and is positioned within an image file such that the rendered image is not contorted. File activity related to the marked image file is tracked.

### FIELD OF THE INVENTION

The present invention relates to the field of file analysis and more specifically to the field of image file tracking

### BACKGROUND

Image files are a frequently protected and secured file format. The need to track, monitor, and analyze image distribution has spawned many, varied techniques for doing so. One of the most popular means of image tracking includes the use of metadata within the file as a storage means.

U.S. Published Patent Application No. 2007/0273774, for example, describes a metadata creation method that is customizable, and can create metadata at the time of image file creation. The '774 Publication purports to disclose a method of tracking digital images includes inputting data identifying a subject of an image into a camera, acquiring an image with the camera, and storing the image and the inputted data, as metadata, in an image file when the image is acquired. The method can be implemented using a scanner, a digital camera, and a data processor. The scanner obtains the identifying data and transmits the data to the camera. The camera obtains digital images and embeds the data into digital image files encoding the digital images. The identifying data has a format different from any of the formats processable by the digital camera. The data processor converts the format of the identifying data to one of the plurality of formats processable by the digital camera loads the converted information into the digital camera as metadata.

Alternatively, U.S. Published Patent Application No. 2004/0201689 discloses a system for applying metadata, or a distinct file, to an existing image file. The '689 Publication purports to disclose a system for recording a log of events that occur to an image file, for example, if the image is e-mailed, printed, edited, etc. Consequently, a user can review the log and know what has been done with the image file previously. This log is preferably generated and maintained automatically. The log may be created when the image file is downloaded to a computer from a digital camera along with a specific instruction or intent of what is to be done immediately with the image file by the computer, e.g., e-mail or print the file. The log may also be created or updated subsequently as the image file is used. The log may be written into the image file or may be written in a separate file that is stored with the image file.

Both the '689 Publication and the '774 Publication include metadata markers, which implies that the metadata is meant to be used by programs knowledgeable of the metadata tag. As U.S. Pat. No. 7,782,372 mentions, metadata may be placed within files and pass unrecognized as metadata. (U.S. Pat. No. 7,782,372; Col. 2, lines 1-55). The '372 Patent purports to disclose an image format for storing digital images within a baseline DCT compatible bitstream comprises entropy coded image data, a first application marker storing a first data value using a first encoding method to convey a first information value related to the image, and a second application marker storing a second data value using a second encoding method to convey the same said first information value related to the image. More specifically, the first application marker uses TIFF tags within an Exif application marker and the second application marker uses a FlashPix compatible structured storage stream, while the entropy coded data includes restart markers to define tile boundaries within the entropy coded image data.

Therefore, there is a need for a file analysis system that is dynamic, is purposefully inert to image-reading programs, permits original event logging, is minimally-detectable to a user, and inert to the depiction of the underlying image within the file.

### SUMMARY

The present invention includes an image security process and system for tracking image file activity within an ecosystem. The process includes identifying an image file. Image files will often be constructed of predefined tags related to the inherent structure of the image file, according to a generalized format schema. The image file is initialized in a non-native reader program that manipulates the file code text, as opposed to graphic attributes of image described by the image file. The image file attributes are determined, principally to recognize the use and location of language related to the file format schema. Rather than utilize the existing schema of the file format language to insert information into the file, information is inserted as a marker inertly into the file code. By inertly, it is meant that the character string utilized is nonconforming with the format schema of the file format. The file information includes at least a file identity. Because the marker is unrecognized as schema and is positioned within the file so as not to be read substantively, the marker fails to alter the output of the image file as an image.

While the image file bears the marker it may be tracked by a master program. The preferred marker includes two components: a marker identifier and marker information. The marker identifier is a tag that is preferably generic to an organization that is searchable to reveal all markers, while the marker information includes the information related to a specific file, user, or other entity. No part of the marker is recognized as schema. The file activity may be tracked and logged in a database or within the file. In other words, the file could contain a portable history of the file or the file could merely contain choice file information that merely identifies the file in reliance on a database for tracking the file activity. Image files may be searched for, the search may be active or passive. The marker may be encrypted.

An image file security system for tracking image file activity includes an identifier to recognize image files. An initializer access the image file, preferably via a non-native reader program adapted to manipulate the file code of the image directly. The reader determines the image file attributes. Based on information from the reader, an inserter inserts the marker within the image file to be inert. It is preferred that file manipulation steps of the present invention are performed via an agent that in local communication to the storage on which the image is utilized. It is preferred that the file activity logging steps are performed by a master central program.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a view of the process of the present invention.

FIG. 2 is a view of the system of the present invention.

FIG. 3 is a view of the system of the present invention.

FIG. 4 is a view of the system performing the process of the present invention.

FIG. 5 is a view of the system performing the process of the present invention.

FIG. 6 is a view of an ecosystem of the present invention.

FIG. 7 is a view of an ecosystem of the present invention.

FIG. 8 is a view of an agent and master program relationship of the present invention.

FIG. 9 is a view of the process of the present invention.

FIG. 10 is a view of the process passively searching files.

FIG. 11 is a view of the process actively searching and marking files.

FIG. 12 is a view of the process of the present invention.

### DETAILED DESCRIPTION

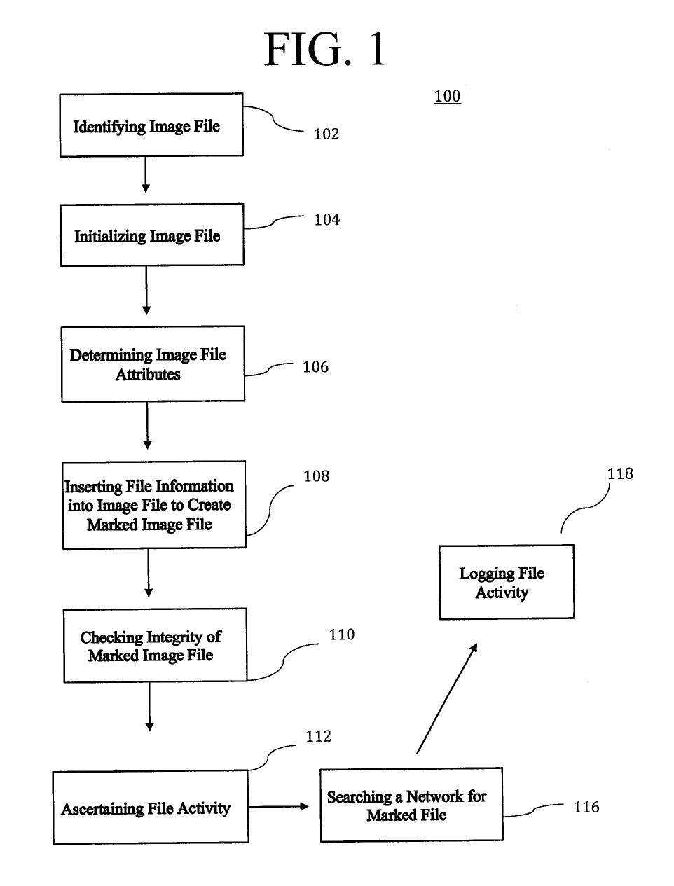

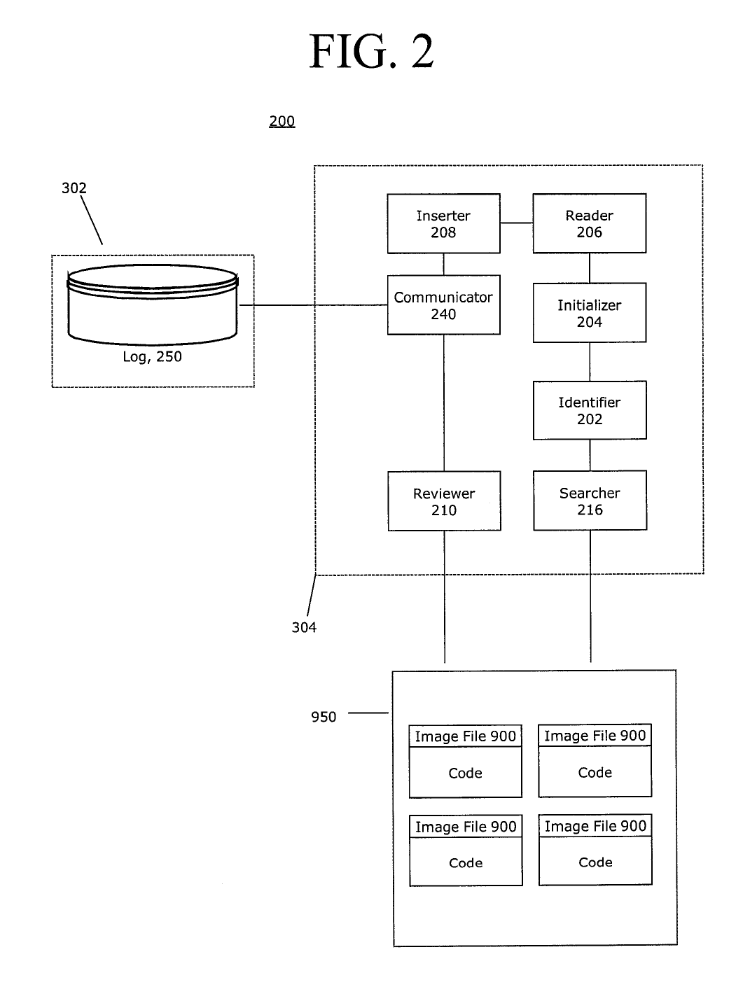

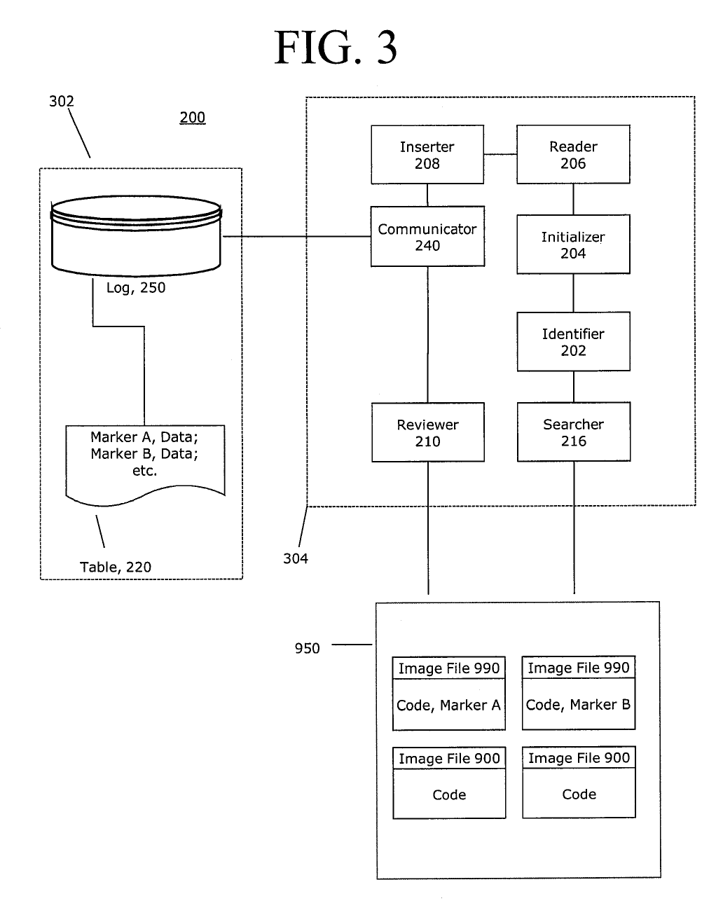

Referring first to FIGS. 1-3, a marked file creation embodiment of the process 100 and system 200 of the present invention are shown. The marked image file creation process 100 includes identifying 102 an image file 900 of an image format. The image formats of the present invention may include any common image formats used to depict raster or vector, or other, images. Examples of raster image formats that may be used with the present invention include the JPEG series of formats, EXIF, TIFF, RAW, GIF, BMP, PNG, PPM, PGM, PBM, PNM, PFM, PAM, WEBP, HDR, RGBE, IFF-RGFX, PSD, and PSP. Examples of vector image formats that may be used with the present invention include AI, CDR, PPT, DWG, DWF, and TCW.

One common format, and the format that will be primarily discussed herein, uses the JPEG (Joint Photographic Experts Group) compression standard, which is well known to those skilled in the art. Although strictly speaking, JPEG refers only to a class of compression algorithms, not to a specific file format, for the purposes of this description, format shall mean the file type of a file. In JPEG terminology, an encoded image area is called a minimal coded unit (or MCU), and it typically represents an eight-by-eight block of pixels. In addition to the compressed pixels, each minimal coded unit also contains a coefficient value for each color channel that is relative to the coefficient value of the corresponding color channel of the previous minimal coded unit. The purpose of using relative coefficients is to reduce the size of the bitstream. Each group is initially represented by 64 bytes. After transforming and removing data, each group is represented by, say, 2 to 20 bytes. During decompression, the inverse transform is taken of the 2 to 20 bytes to create an approximation of the original 8 by 8 group. These approximated groups are then fitted together to form the uncompressed image.

Metadata segments in JPEG files, can contain comments, thumbnails, Exif information (photographic parameters), IPTC information (editorial parameters) and similar data. Each JPEG file is made of consecutive segments (tagged data blocks), and the actual row picture data. Most of these segments specify parameters for decoding the picture data into a bitmap, for example (SOI) and (EOI), which respectively define the start of an image and end of an image. Some of them, namely the COMment, (COM) and APPlication (APP) segments, contain instead metadata, i.e., information about the image. Inherent data structures for JPEG files include: (SOI)=Start Of Image; (EOI)=End Of Image; (SOF)=Start Of Frame header; (SOS)=Start Of Scan header; (ECS)=Entropy Coded Segment (row data, not a real segment); (DNL)=Define Number of Lines segment; (DHP)=Define Hierarchical P segment; (EXP)=EXPansion segment; (RST)=ReSTart segment; (DQT)=Define Quantisation Table; (DHT)=Define Huffman coding Table; (DAC)=Define Arithmetic coding Table; (DRI)=Define Restart Interval; (COM)=comment segment; (APP)=application segment. Each of these tags represents schema of the JPEG file format.

The above data structures are inherent to certain file formats of JPEG. Native JPEG rendering programs read and understand the data structures to acquire information about the image file and ancillary information related thereto. File language that falls outside of the native JPEG structured information is simply “noise” to a native JPEG reading program. Additional file language that is not inherent to the file type can affect a file type in multiple ways. A first effect of noninherent file language in an image file of a given format is to distort the value of the data contained within the image file. A second effect is to alter the instructions of the image file. Simply adding language to an image file need not necessarily alter the image file's output, however; if positioned within the file appropriately, the added language may instead be inert to the rendering, and other substantial operations, of the image file. Because of the popularity of JPEG file formats, the present description will primarily use the JPEG file format as an example; however, the principle of the present invention is applicable to many image formats, particularly those utilizing file mechanics similar or analogous to those described herein.

The process 100 identifies 102 an image file 900 of a JPEG or other image file format. The identifier 202 may identify a JPEG through any means known in the art. A simplistic means of identifying an image file as a JPEG format is an analysis of file nomenclature. JPEG files typically are named with the *.JPG convention. Alternative means of identifying images and image file types include file investigations for internal conventions and characteristics of image files.

The image file 900 is then initialized 104 by an initializer 204 in a non-native reader program 206. By initialized, 104 it is meant that the present invention gains access to the code language of the image file 900. It is not necessary that the initialization 104 include access that understands the code language of the image file 900, particularly as understanding the substance of the code language of the image file 900 will generally be unnecessary. A non-native reader program 206 is a program that is capable of accessing the code language of the image file for purposes other than creating or rendering the image of the image file. The non-native reader program can make non-renderable edits to the code of the image file and can examine the structure of a digital file in a textual format. Such a program may open files of disparate types and categories in a way that exposes the structure of said file. An example of a non-native reader program is a text editor. A nonnative reader can be contrasted with a native reader, which is a program that creates code from an image file or reads file code for the purpose of rendering an image. It is often the case that the reader program 206 includes an initializer, and for purposes of text editors, the initializer 204 may be simply a subroutine of a reader program 206 (or vice versa) that opens the image file.

The reader program 206 determines 106 the file attributes of the image file. By file attributes, it is meant the characteristics of the file that may relate to the code of the image file, the dimensions of the rendered image, the values of the image, the ancillary information embedded within the image code, the structure of the code, etc. One of the file attributes that may be recognized by the determining step includes review of the image file for a marker of the present invention. If the marker is found, any of the file activity processes described in this application may then be applied. The file attributes may be logged 118 in a central log 250, preferably in a table 220 with a time stamp, such that alterations of a particular image file may be tracked and analyzed over time. The file attributes may be communicated via a communicator 240 to a master program or some other entity that tracks the image file. The log may be incorporated in a marked file or maintained in a central repository. Significant attributes of the image file that the present invention may seek are the portions of the image file code that include non-renderable portions or other portions that are not read or understand by a native reader program.

After attributes of the image file have been determined 106, the present invention uses an inserter 208 to insert 108 file information into the image file 900 as a marker. The marker of the present invention is a traceable item that is inserted into the image file for later search, analysis, or other process of the present invention. The marker includes at least two components, the marker identifier 994 and the marker content 996. In the file determination step 106 of the present invention, the data structure of the image file and the sensitive portions of the image are uncovered 106 generally (e.g., the data structures utilized by the file type) and specifically (e.g., the specific commands and meta tags used in a particular image file and the location thereof). The marker content may include one or more components, including at least a marker identifier. The marker may include information related to the user, file, or file activity. An example of a marker of the present invention is: “\\This is a image #1234, accessed by user #1948, for 18 minutes, on machine: PC-101.” Embodiments of the present invention that omit file activity from the marker may rely merely on a character string that solely identifies the user.

A preferred marker identifier is the double slash. The marker identifier is that portion of the marker that is common to multiple users or images and is the result of identification nomenclature rather than a relation to a particular user, file, or file activity. A marker identifier may be common to an entity, subgroup of the entity, or individualized. Furthermore, a marker identifier may be common to an image genre, image characteristics, or other image category. The marker content may include such information as a unique image identifier, user information, and machine information. Other types of file information could include: IP address of machine, machine name, user currently logged in, timestamp of the modification, and filename. Any information that relates to file activity may be stored as marker content. The marker is inertly embedded in the image file.

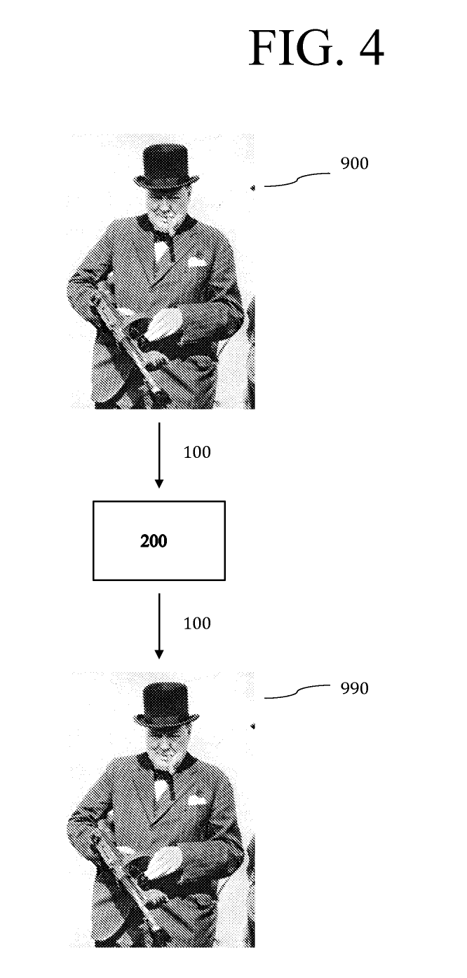

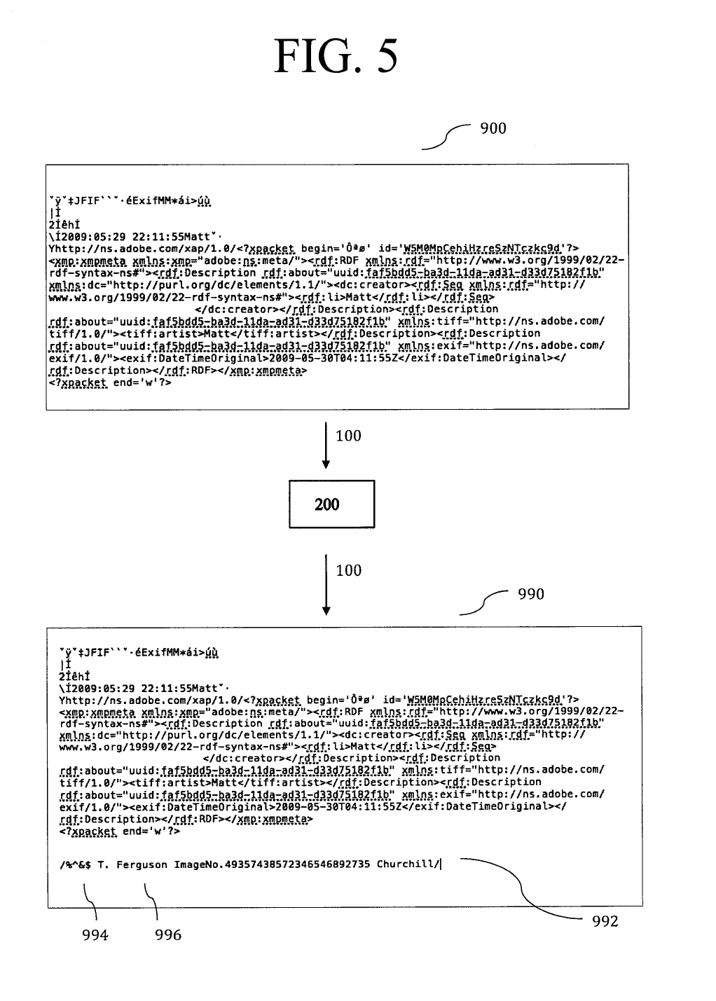

By inertly embedded, it is meant that the file attributes of the image file are studied such that placement of the marker into the image file does not alter the rendered attributes of the image and does not include character combinations interpreted as functional by a native reader program. Simply adding language to an image file need not necessarily alter the image file's output, however; if positioned within the file appropriately, the added language may instead be inert to the rendering, and other substantial operations, of the image file. As shown in FIGS. 4-5, the image file 990 is acquired by the present invention and altered to include the marker 992 of the present invention. The image file becomes a marked image file 990. Inert placement of the image file is a position in the image file code that is unread by a native reader program in the rendering of the image file and not understood as inherent structural language. For example, for a JPEG image, the marker would not include a COM tag and would be placed in a position that is unread.

In FIGS. 4-5 the marker 992 string is placed in the end of the image file 990. By opening a JPEG in a plain text editor, a unix based system will automatically assign the values of the elements in the matrix to text string variables, generating a TXT file with the same byte information. At the end of the image file, the EOI tag has communicated to the native reader program that the substantive portions of the image within the image file has concluded and therefore any image-substantive information placed after the EOI tag is ignored. Thus, the placement of the marker 992 does not affect the rendering of the image file 900 as a marked image file 990. For all intents and purposes of a user, the depiction of the image is unaffected. The means of insertion of a marker within an image file may be according to any of the following means: (1) insertion of the marker character string in a position that is not read by a native reader program for rendering purposes, and does not use the inherent language structure of the image file type, (2) insertion of the marker character string in a position that is read by the native reader program but does not affect the rendering of the image and does not use the inherent language structure of the image file type. Preferred placement of the marker is at the end of the image file. It is even more preferred that the marker character string include encrypted information to prevent unauthorized access to the marked file information.

Common image files include a standardized format. This format describes file construction schema that provides a native reader program, that is to say a program that is adapted to read and then display the image file as an image, the ability to parse the image file into its separate components for purposes of using the image file as an image. The inserter utilizes language that is not recognized as schema and therefore is not read as a part of the file by a native reader program. However, it may be a part of the present invention to purposefully utilize language that is imitative of the schema to fool cursory inspections of the file code.

Returning to FIGS. 1-3, the present invention may then check 110 the integrity of the marked image file with a reviewer 210. The reviewer 210 may have the capacity to measure the rendered differences between the original image file and the marked image. The reviewer 210 preferably measures that the difference between the rendered versions of the original and marked image file as a threshold. The preferred threshold may be zero percent difference, but the threshold may be altered to allow some minor differences between the original and marked image. A simpler and preferred version of the reviewer 210 may include a subroutine that simply ensures that the file type nomenclature of the marked file and the file type nomenclature of the original file are identical. As opening JPEG files in a text editor will default the file type to a .TXT nomenclature, retaining the .TXT alteration will hinder the usefulness of the image of the original image file. The reviewer will ensure that the marked file retains, or is returned to, its original nomenclature.

The prevent invention 100, 200 extends considerably beyond the creation of marked image files. The present invention 100, 200 further includes tracking the marked image files. The present invention may search 116 a particular storage medium 950 for both image files 900 that may be marked and marked image files 990. The present invention should be adjustable by a user to specify which types of files, file types, and other indicia the present invention should seek. Furthermore, the present invention should be adjustable to permit customized network searching 116 to include timed searching (irrespective of image file activity) and logging 118, triggered searching such that image file activity is recognized and logged 118 only when a file is accessed, used, or otherwise affected.

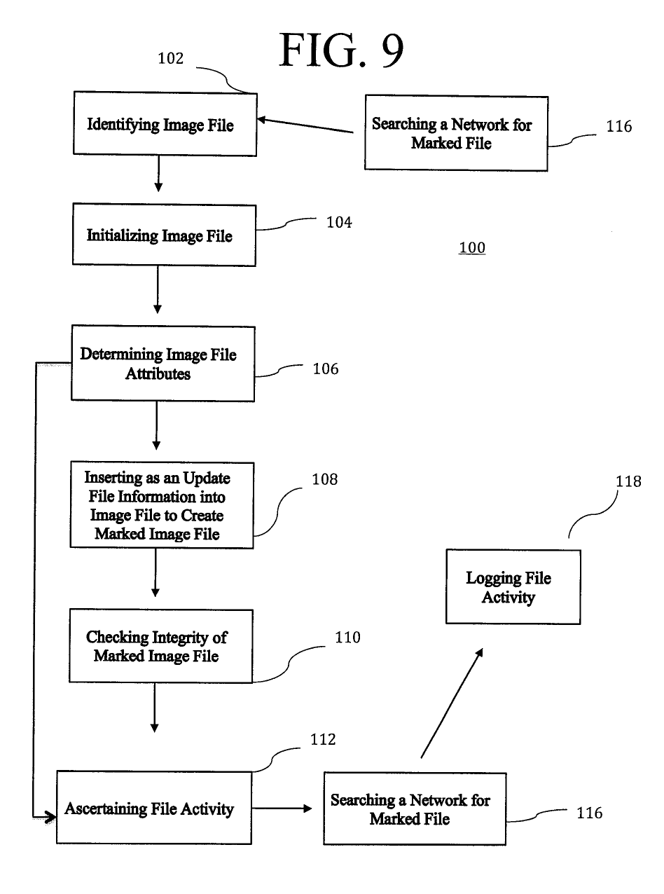

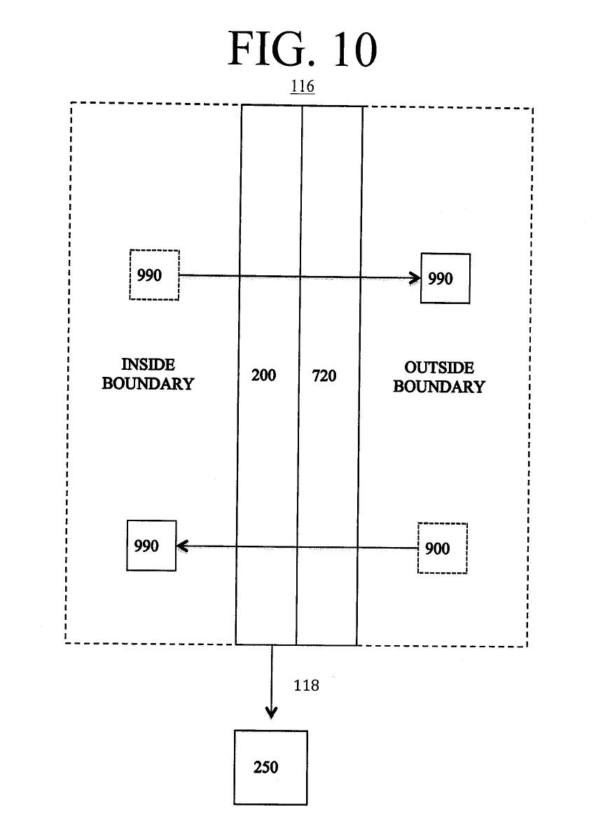

Searching 116 by a searcher 216 of the present invention may be active or passive. As shown in FIGS. 9-12, searching a network for a marked file 116 may take many forms. Searching for a marked file may include active or passive searching. A preferred configuration for passive searching of a network includes boundary monitoring as shown in FIG. 10. The system 200 is positioned at a network boundary 720 in order to be in the file path of image files entering and leaving an ecosystem. As image files 900 enter the ecosystem, the image files are marked. Logging 118 should begin as soon as the image file 900 enters the boundary and may be performed periodically while the image file is within the ecosystem. Image files, which have presumably been marked as marked image files 990, that leave the boundaries of the ecosystem remain marked. Image files that return to the ecosystem may be remarked, have the mark updated, or otherwise manipulated according to the present invention.

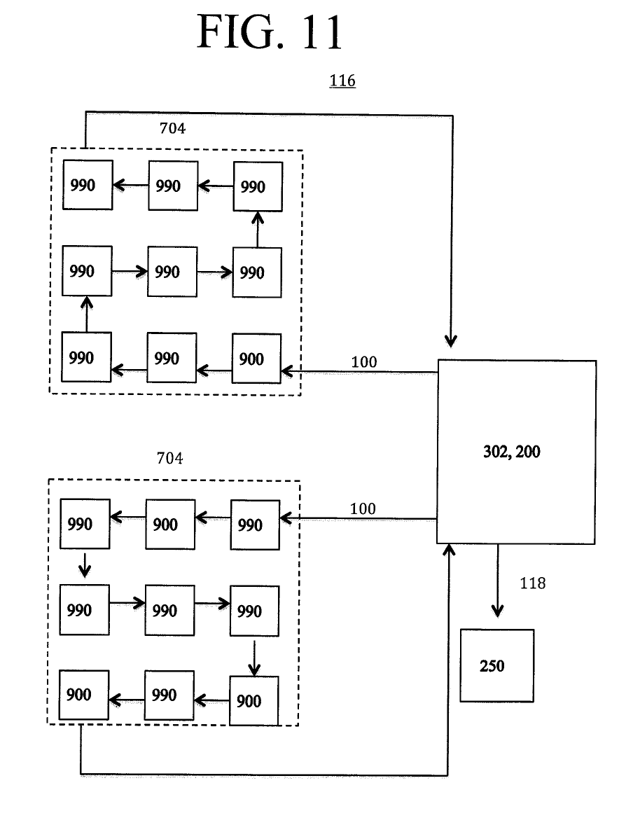

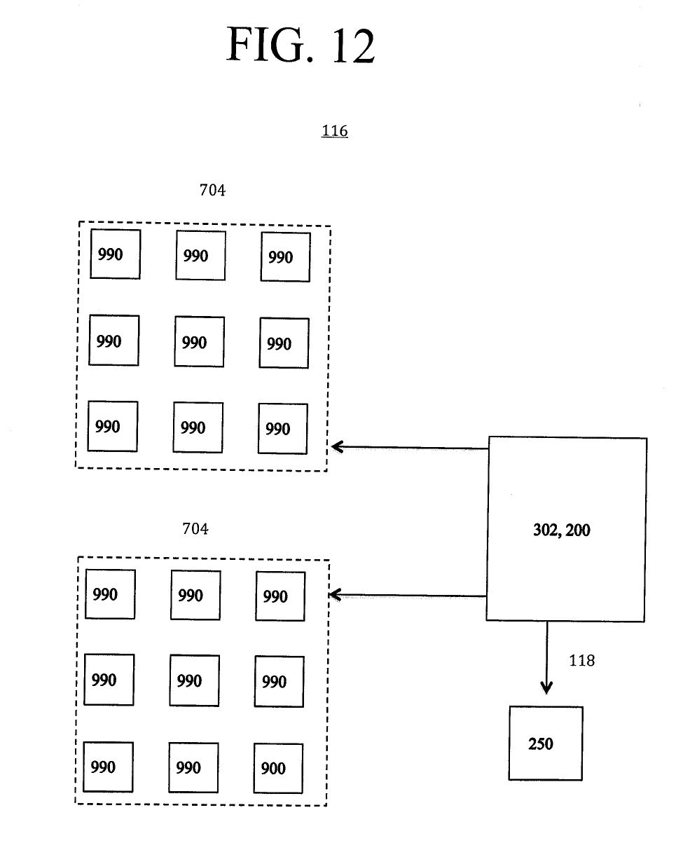

FIG. 11 depicts an active search 116 of a network of the present invention. A query or other command for search instigates a routine to seek image files of the present invention. This scouring may include any of the steps of the present invention, including those that mark image files 900, update/re-mark marked image files 990, or otherwise in the storage media 704 of an ecosystem. It is preferred that this scouring occur by the master monitoring program 302 which logs 118 file activity within the log database 250. As shown in FIG. 12, it is preferred that all image files uncovered by the system 200 are marked image files or are converted to marked image files 990. By marking the files, the term “marking” and “mark” includes any type of manipulation of the marker, such as initial placement, updating, alteration, etc.

The present invention may be segmented into at least two portions, a central master monitor program and a program agent. The central monitor program may be installed on a central machine in an organization's computer ecosystem with access to other computers on the ecosystem. The central monitoring program may be installed on a single computer. The program agent may be installed on multiple machines within the ecosystem of the organization, preferably one agent per computing device. The agent operates at a level that is relatively transparent to the user background service that requires minimal bandwidth, network connectivity, and processing power. When a new jpeg is part of a file activity, including being downloaded, moved within a directory, opened or otherwise imported, the agent detects the action through an actions filter, also known as a mini-filter. The mini-filter is an operating system level utility that is able to detect the action taken upon the file type of interest by monitoring all user actions on the machine. Any such action that relates the activity of an image file to an entity adapted to detect such activity is termed “ascertaining” herein.

A communicator 240 of the present invention may be utilized if the present invention is maintained as a master/agent system and process. Rather than attempt to retain image file information within the agent of the storage media bearing the agent, the agent may make the information ready for a transfer to the master central program, or storage media accessible thereto. The transmission may be contemporaneous to the file activity or aggregated for a later transmission.

As a file activity (which may include a modification, alteration, tamper, edit, or other transaction) occurs, a mini-filter begins to log 118 the important details of the file activity including the user currently logged into the machine (may be defined by active directory, or local directory), the directory location of the image, the time at which the document was modified, and the IP address of the machine currently modifying the document. Finally, the agent may update the marker within the document to reflect the recent event. Alternatively, the agent may forego updating the marker of the file and merely inform the central program monitor of the file activity for incorporation within a file activity database.

The database includes a collection of details pertaining to the creation, modification, and consumption of the image files. The server will then perform analytics on the global consumption of the files based on the database and report the findings back to the user.

The preferred means of searching the network ecosystem of the present invention includes using a means of detection of file activity in which a system determines whether a file is used, and then the present invention examines the file of the file activity to determine whether a marker is included in the file. Thus the marker identifier used with the marker of the present invention should be both original and uncommon to permit pre-existing search programs to be used with the present invention. An example of a marker identifier designed to avoid conflict with other search programs includes /@$!!$#/.

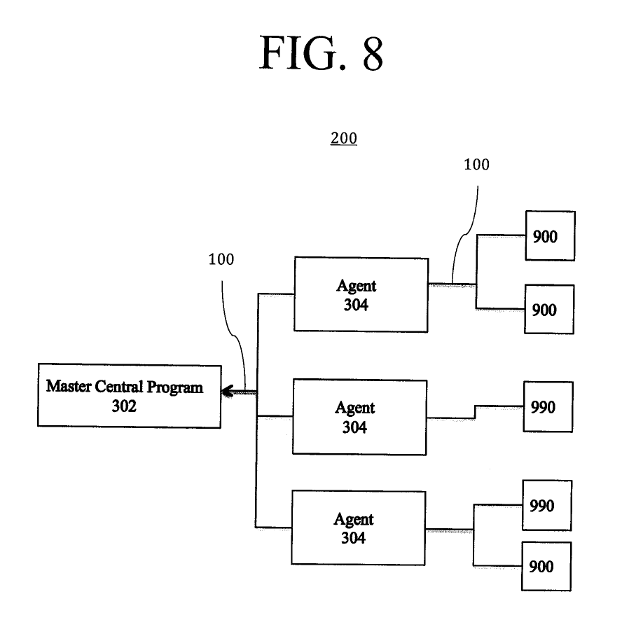

The present invention may also be used as an analysis tool. For proper analysis, the present invention tracks file activity of the marked files and enters 118 the file activity in a log 250. The database 220 that includes the file activity data may include any of the activity that is logically related to the marked image file, including creator, users, family tree data, recipients, modifications, time stamps, etc. In a preferred embodiment shown in FIG. 8 of the present invention, the system and method rely on agents dispersed among all machines within an organization's ecosystem. The agents are in communication with a master central program 302 that receives updates from the agents 304. In such an embodiment, the preferred marker includes the marker identifier and marker content that consists solely of the identity of the marked image file 990. Rather than embed file actions or indicia thereof within the file as marker content, file activities are only sent and tracked via the log as maintained by the master program, and correlated with the identity of the graphic. The agent performs the insertion of the marker and any updates to the marker.

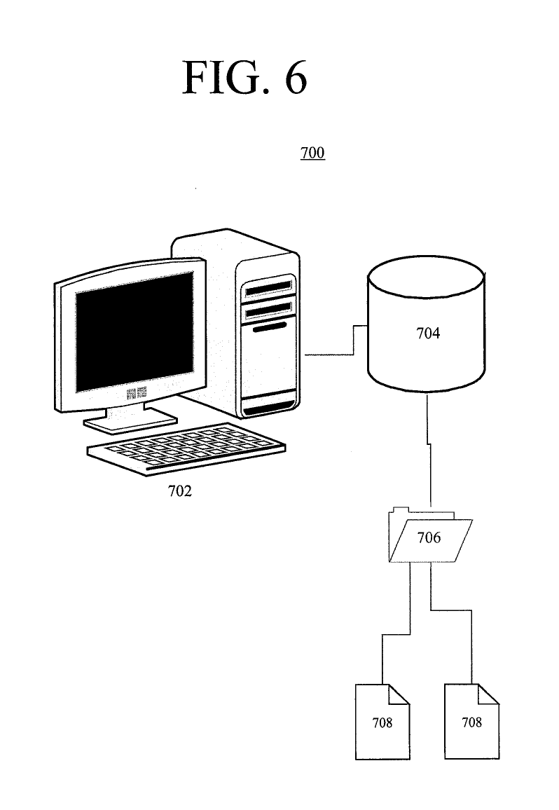

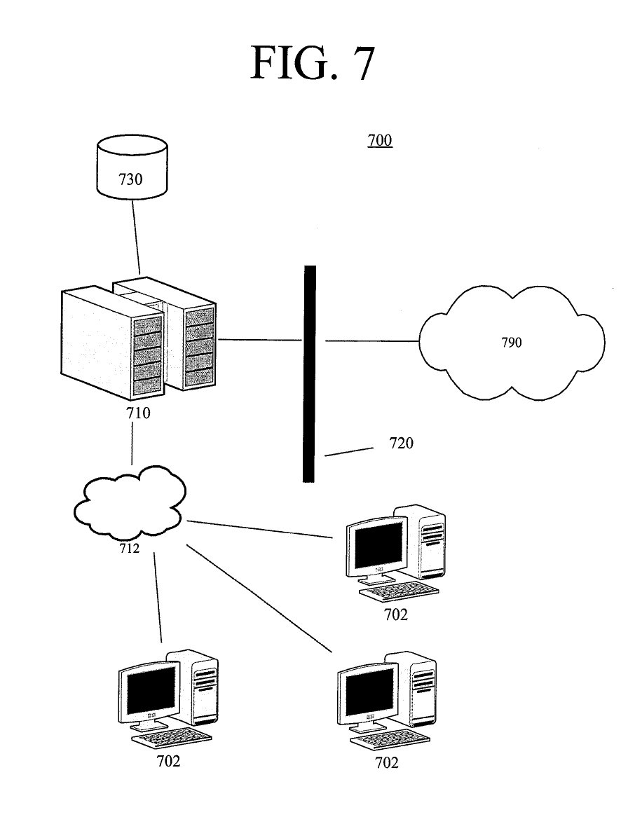

FIGS. 6 and 7 depict a computer ecosystem 700 of the present invention. By ecosystem it is meant one or more computers 702 that are organizationally related. The ecosystem may include computers under common ownership, computers that belong to the same network or series of networks, computers that are collaborating, etc. The present invention may be provided as a computer program product, or software that may include a computer-readable storage medium 704 having stored thereon instructions, which may be used to perform the process of the present invention across a computer ecosystem 700 according to the various embodiments disclosed herein.

A computer 702 of the present invention may include any combination of one or more computer readable media 704. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium 704 may be any tangible medium that can contain, or store a program for use by or in connection with an instruction execution system, apparatus, or device.

A computer readable signal medium 704 may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures described below illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Furthermore, the functionality of one block may be subsumed by the functionality of another block as a substep thereof. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

An ecosystem 700 may further include a computer network or data network that allows computers to exchange data. In a computer network of the present invention, networked computing devices pass data to each other along data connections. The connections between nodes are established using cable media, wireless media, or other media. The Internet or other exterior network 790 may be a component of the ecosystem 700. Nodes may include hosts such as personal computers, phones, servers, and networking hardware. Two such devices are networked together when one device is able to exchange information with the other device, whether or not they have a direct connection to each other. Computer networks of the present invention support applications such as access to the World Wide Web, shared use of application and storage servers, printers, and fax machines, and use of email and instant messaging applications. Computer networks may be included irrespective of the physical media used to transmit their signals, the communications protocols to organize network traffic, the network's size, topology, and organizational intent.

It is preferred that the network of the present invention have at least one boundary 720, and potentially multiple boundaries if a demilitarized zone is utilized. The boundary 720 may include any number of layers designed to regulate and secure the flow of information between networks. Boundary layers of the present invention may include enterprise content management software, firewalls, filters, threat management software, alarms, etc. Software for establishing a boundary may be run on a server 710 with server storage 730 of the present invention, which may include directory services controlling access credentials. The present invention may be applied to intercept transmissions passing through the ecosystem boundary for marking image files with the marker.

To combat security risks posed by network connections, firewalls are frequently used. A firewall may be a hardware or software component that filters network traffic so that communications with unauthorized third parties are blocked but legitimate network functions may be carried out. Frequently, the filters applied by a firewall are specified by a set of policies defining characteristics of network messages that either should pass through the firewall or that should be blocked. Because different levels of communication may be appropriate depending on the origin or destination of messages, firewall policies may be provided for each application that executes on a computing device and communicates over a network.

A firewall may have an outward side facing a global network, such as the Internet. The opposite side of the firewall may be a private network that is protected by the firewall. The private network may include any number of host machines (e.g., computers) each addressable by its own IP address. The physical construction of the network may be such that all data packets intended for one of the IP addresses behind the firewall pass through the firewall. Using the firewall rules, which may be set by a network administrator or other user, the firewall may determine whether to allow or deny certain data packets and/or determine where to route particular data packets based on the IP addresses to which the packets are directed. The determination of where to route data packets may be done using the IP addresses of the host machines in the private network.

Depending on the addressing scheme used by the network, the IP addresses of the host machines may be static or dynamic. Static IP addresses do not change over time, and thus once they are set in the firewall rules, there is no need to update them. The Internet Protocol version Four (IPv4) addressing system commonly uses static addressing, while IPv6 may use dynamic addressing. Dynamic IP addresses may change over time and thus, there is a need to update the firewall rules as changes occur. When a small Local Area Network (LAN), such as a domestic network in a private residence, is linked to a larger network such as the Internet, the link is often through a gateway router acting as a firewall. One of the functions of the firewall is to protect the LAN from intrusion from outside.

A service directory accessible by a server 710, usually on server storage 730, stores information about network resources across a domain. An example of a directory service is Active Directory. The main purpose of Active Directory is to provide central authentication and authorization services for Windows-based computers. Active Directory also allows administrators to assign policies, deploy software, and apply critical updates to an organization. Active Directory stores information and settings in a central database.

An Active Directory structure is a hierarchical framework of objects. The objects fall into three broad categories: resources (e.g. printers), services (e.g. e-mail) and users (e.g., user accounts and groups). The Active Directory provides information on the objects, organizes the objects, controls access and sets security. Certain objects can also be containers of other objects. An object is uniquely identified by its name and has a set of attributes--the characteristics and information that the object can contain--defined by a schema, which also determines the kind of objects that can be stored in the Active Directory.

Typically, the highest object in the hierarchy is the domain. The domain can be further sub-divided into containers called Organizational Units. Organizational units give a semblance of structure to the organization either based on administrative structure or geographical structure. The organizational unit is the common level at which to apply group policies, which are Active Directory objects themselves called Group Policy Objects. Policies can also be applied to individual objects or attributes as well as at the site level (i.e., one or more IP subnets).

The present invention may use one of more communication networks to foster information exchange throughout the computers of the ecosystem. Communication networks might either be private or public. In a private network, communications between multiple computers occur in a secure environment that prevents access from outside the network without appropriate authentication. These networks are considered as “trusted” networks because the communication signals securely travel from one computer to another within the private network without being exposed to the external environment.

Public networks such as the Internet, on the other hand, are not secure because the communication over these networks is not private and is susceptible to interception by other computers. In addition, the public networks cannot guarantee the delivery of the data packets being sent. They allow packets to be injected into, or ejected out of, the networks indiscriminately, and analyzed while in transit. To keep data sent over a public network private, a Virtual Private Network (VPN) is commonly established on top of a public network when two computers use the public network to communicate with each other. In a Virtual Private Network, data sent from one computer to another is encrypted by a security gateway and transmitted in encrypted form over the public network to a second security gateway connected to the receiving computer. The second gateway decrypts the data before forwarding it to the receiving computer. Such a private channel established on top of another network is referred to as a network tunnel.

In order to set up a Virtual Private Network, a user first establishes a path to a VPN server and goes through an AAA process (Authentication, Authorization and Accounting) for identification and authorization to create a secure tunnel with the server. Once the user is authorized, a secure network tunnel is established between the user and the VPN server over the public network, using a VPN protocol such as IPsec. This process requires a VPN client on the user's side, a VPN server and other VPN hardware on the other side of the tunnel, as well as appropriate user configurations.

Today's private networks often include wireless networks such as WiMAX to accommodate mobile access. In addition, to provide mobility access in a large geographic area, a private enterprise often relies on third-party wireless infrastructures besides its own wireless network. In this case, a user's device would need to be authenticated by both a third-party gateway and an enterprise authentication server before it could access the enterprise network. User credentials are typically requested by and securely returned to the third-party gateway. Once the user is authenticated and authorized, the user may communicate with the third-party wireless gateway.

The present invention includes files 708, which may or may not be image files 900, 990, which may include executable instructions by which the present invention runs, or files upon and with which the present invention interacts. The documents may be on local storage 704 or shared storage 730 and be created, accessed, edited, and/or otherwise modified using any of a number of applications, including for example and without limitation Final Cut Pro, Avid, Microsoft Office applications (Word, Excel, Power Point, Outlook, Visio, etc.), Adobe Reader or Acrobat, AutoCAD, SolidWorks, or any other suitable document editing application. The content of the documents may be audio tracks, video clips, images, word processing documents, presentations, spreadsheets, business documents, engineering documents, databases, etc. Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A process for updating a marked image file, said process comprising:
searching for a marked image file, on a nontransitory readable storage medium, of an image file format utilizing predefined format schema adapted to display an image, wherein said marked image file includes:
file information inserted as a character string inertly within said image file as a marker, wherein said marker includes a common general identifier that is nonconforming with said format schema of said file type and includes file information including at least a file identity, wherein said marker as inertly inserted fails to alter an output of said image file as said image;
initializing said image file in a non-native reader program adapted to manipulate file code on a textual level generally and said image file format code and image file content code of said image on a textual level;
determining said image file attributes; and
updating said marked image file to include updated file information inserted as a character string inertly within said image file as a marker to create an updated image file, wherein said marker includes said common general identifier that is nonconforming with said format schema of said file type and includes file information including at least a file identity, wherein said marker as inertly inserted fails to alter an output of said image file as said image.

2. The process of claim 2 further comprising the step of ascertaining a file activity related to said marked file.

3. The process of claim 2 wherein said searching step includes passively receiving a file activity update for said marked file based on said file activity.

4. The process of claim 3 wherein said searching step includes passively receiving a file activity update for image files and scanning said image files for said marker to ascertain marked image files.

5. The process of claim 2 wherein said searching step includes actively scouring a network ecosystem for at least one marked file.

6. The process of claim 2 further comprising the step of logging said file activity as file activity data in a log database.

7. The process of claim 1 wherein said inserting step includes inserting encrypted file information within said marked file.

8. A system for updating a marked image file bearing image file activity information, said system comprising:
a searcher for searching for a marked image file, on a nontransitory readable storage medium, of an image file format utilizing predefined format schema adapted to display an image, wherein said marked image file includes:
file information inserted as a character string inertly within said image file as a marker, wherein said marker includes a common general identifier that is nonconforming with said format schema of said file type and includes file information including at least a file identity, wherein said marker as inertly inserted fails to alter an output of said image file as said image;
an initializer for accessing said image file in a non-native reader program;
said reader program for determining said image file attributes; and
an inserter for updating said marked image file to include updated file information inserted as a character string inertly within said image file as a marker to create an updated image file, wherein said marker includes said common general identifier that is nonconforming with said format schema of said file type and includes file information including at least a file identity, wherein said marker as inertly inserted fails to alter an output of said image file as said image.

9. The system of claim 8 further comprising an agent adapted to ascertain file activity related to said marked file.

10. The system of claim 8 wherein said searcher passively receives a file activity update for said marked file based on said file activity.

11. The system of claim 9 wherein said searcher passively receives a file activity update for image files and scans said image files for said marker to ascertain marked image files.

12. The system of claim 8 wherein said searcher actively scours a network ecosystem for at least one marked file.

13. The system of claim 8 further comprising a log database for logging said file activity data.

14. The system of claim 8 wherein said agent includes inserting encrypted file information within said marked file.
